(19) United States
(12) Patent Application Publication
(10) Pub. No.: US 2025/0118494 A1
(43) Pub. Date: Apr. 10, 2025

(54) MULTILAYER CERAMIC ELECTRONIC COMPONENT AND METHOD FOR MANUFACTURING SAME

(71) Applicant: TAIYO YUDEN CO., LTD., Tokyo (JP)

(72) Inventors: Kenji TAKASHIMA, Takasaki-shi (JP); Kazuki KAWAI, Takasaki-shi (JP); Mika NISHIZAWA, Takasaki-shi (JP); Kazuho MURATA, Takasaki-shi (JP)

(21) Appl. No.: 18/819,270

(22) Filed: Aug. 29, 2024

(30) Foreign Application Priority Data
Oct. 5, 2023 (JP) 2023-173725

(51) Int. Cl. H01G 4/12; H01G 4/30

(52) U.S. Cl. CPC H01G 4/1281; H01G 4/30

(57) ABSTRACT

A multilayer ceramic electronic component includes an element body formed by alternately stacked internal electrode layers and dielectric layers. The abundance ratio of crystals of the cubic crystal system in grains that form the dielectric layers sandwiched by the internal electrode layers is 25% by mass or higher but no higher than 75% by mass, and the average grain size of the grains that form the dielectric layers sandwiched by the internal electrode layers is 30 nm or larger but no larger than 70 nm. The multilayer ceramic component is intended to maintain a high dielectric constant while offering good DC bias properties.

### CROSS-REFERENCE TO RELATED APPLICATIONS

The present application claims priority to Japanese Patent Application No. 2023-173725, filed Oct. 5, 2023, the disclosure of which is incorporated herein by reference in its entirety including any and all particular combinations of the features disclosed therein.

### BACKGROUND

### Field of the Invention

The present invention relates to a multilayer ceramic electronic component and a method for manufacturing the same.

### Description of the Related Art

Multilayer ceramic electronic components having a capacitive part comprising alternately stacked internal electrodes and dielectric layers are known of late. Such multilayer ceramic electronic components may experience a drop in electrostatic capacitance due to a direct-current voltage applied to the dielectric layers (DC bias properties). Various proposals have heretofore been made to improve the DC bias properties (refer to Patent Literature 1, for example).

### BACKGROUND ART LITERATURES

Patent Literature 1: Japanese Patent Laid-open No. 2006-56765

### SUMMARY

Against the backdrop of an accelerating miniaturization of electronic equipment in which multilayer ceramic electronic components are used, there is a demand for multilayer ceramic electronic components that are smaller in size and larger in capacity. This requires further improvements in multilayer ceramic electronic components from the viewpoint of maintaining a high dielectric constant while offering good DC bias properties.

An object of the present invention is to provide a multilayer ceramic electronic component that maintains a high dielectric constant while offering good DC bias properties.

The aforementioned object is achieved by a multilayer ceramic electronic component comprising an element body formed by alternately stacked internal electrode layers and dielectric layers, wherein the abundance ratio of crystals of the cubic crystal system in grains that form the dielectric layers sandwiched by the internal electrode layers is 25% by mass or higher but no higher than 75% by mass, and the average grain size of the grains that form the dielectric layers sandwiched by the internal electrode layers is 30 nm or larger but no larger than 70 nm.

The multilayer ceramic electronic component of the aforementioned constitution can be an embodiment in which the abundance ratio of crystals of the cubic crystal system in the grains is 35% by mass or higher but under 65% by mass.

The multilayer ceramic electronic component of the aforementioned constitution can be an embodiment in which (depending on the embodiment) all, a predominant number, a majority, or representative grains of the grains that form the dielectric layers, each comprise a core part primarily constituted (characterized) by crystals of the tetragonal crystal system, and a shell part surrounding the periphery of the core part and primarily constituted (characterized) by crystals of the cubic crystal system.

The multilayer ceramic electronic component of the aforementioned constitution can be an embodiment in which the abundance ratio (%) of crystals of the cubic crystal system represents the value obtained by performing the X-ray analysis method on a measurement sample in powder form resulting from pulverizing the capacitive part constituted by the dielectric layers that are stacked with the internal electrodes and present between the internal electrodes, and then fitting the obtained X-ray diffraction pattern by Rietveld analysis using a multiphase model constituted by the crystals of the cubic crystal system and crystals of the tetragonal crystal system, thereby calculating the ratios (% by mass) of the crystals of the cubic crystal system and crystals of the tetragonal crystal system, respectively, with the crystals of the cubic crystal system and crystals of the tetragonal crystal system together accounting for 100%.

The multilayer ceramic electronic component of the aforementioned constitution can be an embodiment in which the dielectric layers contain at least one of Mg, Ho, Yb, Er, and Mn.

The multilayer ceramic electronic component of the aforementioned constitution can be an embodiment in which the grains constituting the dielectric layers contain at least one type of element selected from Ba, Sr, and Ca, as well as at least one type of element selected from Ti, Zr, and Hf, where the atomic ratio (at %) of the Ba, Sr, and Ca combined is equal to or higher than 1.020 times, or equal to or lower than 0.96 times, the atomic ratio (at %) of the Ti, Zr, and Hf combined.

Additionally, the aforementioned object is achieved by a method for manufacturing a multilayer ceramic electronic component comprising: a step to obtain a ceramic slurry that contains a ceramic powder synthesized by the hydrothermal synthesis method and comprising core parts primarily constituted by crystals of the tetragonal crystal system and shell parts surrounding the periphery of the core parts and primarily constituted by crystals of the cubic crystal system; a step to produce green sheets using the ceramic slurry; a step to form a laminate body in which the green sheets are alternately stacked with metal conductive layers; and a step to form dielectric layers from the ceramic powder by sintering the laminate body; wherein the hydrothermal synthesis method is implemented in a synthesis environment of 600 hPa or higher but no higher than 2000 hPa in pressure and 60° C. or higher but no higher than 120° C. in temperature.

The method for manufacturing multilayer ceramic electronic component of the aforementioned constitution can be an embodiment in which the average grain size of the ceramic powder is 20 nm or larger but no larger than 50 nm and the ceramic powder contains BaTiO₃.

The method for manufacturing a multilayer ceramic electronic component of the aforementioned constitution can be an embodiment in which the ceramic powder is synthesized in the synthesis environment over a period of 30 minutes or longer but within 100 hours.

The method for manufacturing multilayer ceramic electronic component of the aforementioned constitution can be an embodiment in which the step to obtain a ceramic slurry includes a step to add to the ceramic powder a grain growth-inhibiting additive that inhibits growth of the grains contained in the ceramic powder.

The method for manufacturing multilayer ceramic electronic component of the aforementioned constitution can be an embodiment in which the grain growth-inhibiting additive is at least one of Mg, Ho, Yb, Er, and Mn.

The method for manufacturing multilayer ceramic electronic component of the aforementioned constitution can be an embodiment in which at least one type of element selected from Ba, Sr, and Ca and at least one type of element selected from Ti, Zr, and Hf are contained, and the atomic ratio (at %) of the Ba, Sr, and Ca combined is equal to or higher than 1.020 times, or equal to or lower than 0.96 times, the atomic ratio (at %) of the Ti, Zr, and Hf combined.

Additionally, the method for manufacturing a multilayer ceramic electronic component of the aforementioned constitution can be an embodiment in which, when the atomic ratio (at %) of the Ba, Sr, and Ca combined is equal to or higher than 1.020 times the atomic ratio (at %) of the Ti, Zr, and Hf combined, the atomic ratio (at %) of the Ba, Sr, and Ca combined is equal to or lower than 1.100 times the atomic ratio (at %) of the Ti, Zr, and Hf combined.

Furthermore, the method for manufacturing a multilayer ceramic electronic component of the aforementioned constitution can be an embodiment in which, when the atomic ratio (at %) of the Ba, Sr, and Ca combined is equal to or lower than 0.96 times the atomic ratio (at %) of the Ti, Zr, and Hf combined, the atomic ratio (at %) of the Ba, Sr, and Ca combined is equal to or higher than 0.900 times the atomic ratio (at %) of the Ti, Zr, and Hf combined.

According to the present invention, a multilayer ceramic electronic component that maintains a high dielectric constant while offering good DC bias properties can be provided.

### BRIEF DESCRIPTION OF THE DRAWINGS

FIG. 1 is a perspective view of a multilayer ceramic capacitor pertaining to an embodiment of the present invention.

FIG. 2 is a cross-sectional view along line A-A′ of the multilayer ceramic capacitor in FIG. 1.

FIG. 3 is a cross-sectional view along line B-B′ of the multilayer ceramic capacitor in FIG. 1.

FIG. 4 is a drawing schematically illustrating the state of a grain forming a dielectric layer.

FIG. 5A is a drawing schematically illustrating a cubic crystal contained in a grain forming a dielectric layer, while FIG. 5B is a drawing schematically illustrating a tetragonal crystal contained in a grain forming a dielectric layer.

FIG. 6 is a flowchart showing an example of how the multilayer ceramic capacitor in the embodiment is manufactured.

FIG. 7 is a graph showing the DC bias properties of one example and one comparative example.

### DESCRIPTION OF THE SYMBOLS

| | |
|---|---|
| 10 | Multilayer ceramic capacitor |
| 11 | Ceramic body |
| 12, 13 | Internal electrode |
| 14a, 14b | External electrode |
| 21 | Base film |
| 22 | Plated film |
| 151 | Grain |
| 151a | Core part |
| 151b | Shell part |

### DETAILED DESCRIPTION OF EMBODIMENTS

Embodiments of the present invention will be explained below by referring to the drawings.

The drawings show, as deemed appropriate, the X-axis, Y-axis, and Z-axis that are orthogonal to one another. The X-axis, Y-axis, and Z-axis are common to all drawings. The X-axis direction, Y-axis direction, and Z-axis direction correspond to the third-axis direction, second-axis direction, and first-axis direction, respectively.

### [Overall Structure of Multilayer Ceramic Capacitor 10]

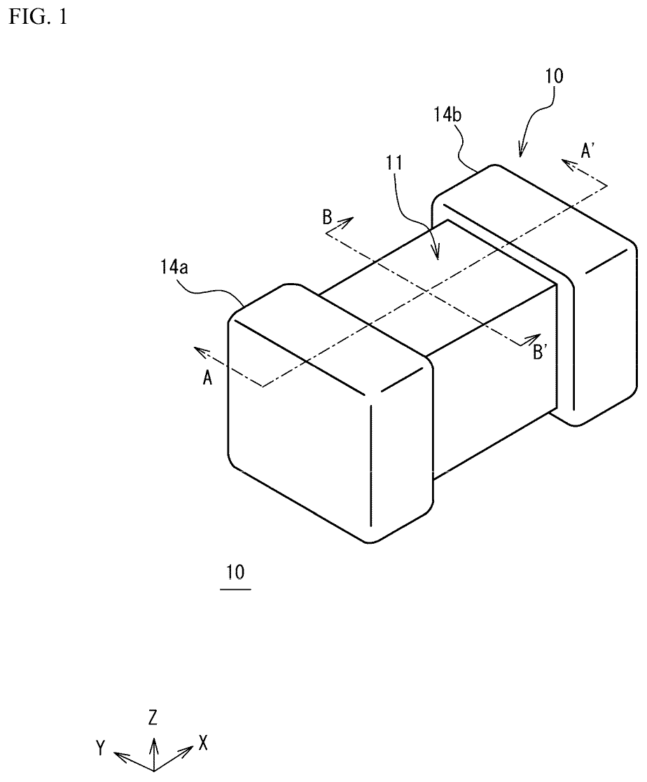

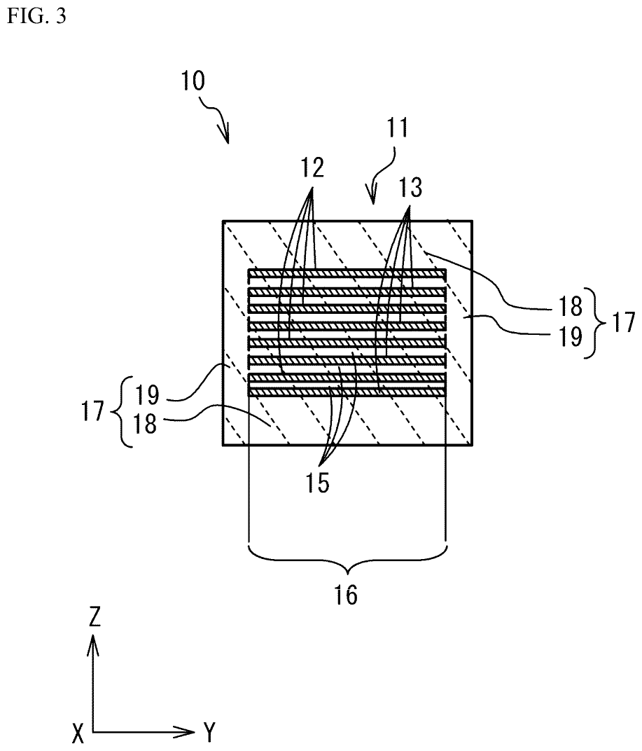

The multilayer ceramic capacitor 10 comprises an element body 11 having a roughly rectangular solid shape. Of the element body 11, the four faces other than the top face and bottom face in the stacking direction are referred to as “side faces.” As illustrated in FIGS. 1 to 3, the element body 11 has a first external electrode 14a and a second external electrode 14b provided on two opposing side faces (first side face and second side face), respectively. The first external electrode 14a extends from the first side face to the four adjoining faces. The second external electrode 14b extends from the second side face to the four adjoining faces. However, the first external electrode 14a and second external electrode 14b are separated from each other.

It should be noted that, in FIGS. 1 to 3, the Z-axis direction (first direction) represents the stacking direction, which is the direction in which the internal electrode layers lie facing one another. The X-axis direction (second direction) represents the length direction of the element body 11, which is the direction in which the first side face and second side face of the element body 11 lie facing each other and the direction in which the first external electrode 14a and second external electrode 14b lie facing each other. The Y-axis direction (third direction) represents the width direction of the internal electrodes, which is the direction in which the two side faces other than the first side face and second side face among the four side faces (third side face and fourth side face), of the element body 11, lie facing each other. The X-axis direction, Y-axis direction, and Z-axis direction are orthogonal to one another.

The element body 11 has a structure in which dielectric layers 15 containing a ceramic material that functions as a dielectric body, and internal electrode layers, are alternately stacked. The internal electrode layers include multiple first internal electrode layers 12 and multiple second internal electrode layers 13. The first internal electrode layers 12 and second internal electrode layers 13 are alternately stacked. The edges of the first internal electrode layers 12 are led out to the first side face of the element body 11 on which the first external electrode 14a is provided. The edges of the second internal electrode layers 13 are led out to the second side face of the element body 11 on which the second external electrode 14b is provided. This way, the first internal electrode layers 12 and second internal electrode layers 13 are electrically connected to the first external electrode 14a and second external electrode 14b alternately. As a result, the multilayer ceramic capacitor 10 has a structure in which capacitor units are stacked. Also, in the laminate body constituted by the dielectric layers 15 and internal electrode layers, internal electrode layers are placed as the outermost layers in the stacking direction, and the top face and bottom face of the laminate body are covered with cover parts 18. The cover parts 18 use a ceramic material as the primary component. It should be noted that the structure is not limited to that in FIGS. 1 to 3 so long as the first internal electrode layers 12 and second internal electrode layers 13 are exposed to different regions on the surface of the laminate body and electrically connected to the different external electrodes. The “different regions on the surface of the laminate body” may be the respective surface regions of any opposing faces of the laminate body, or respective surface regions of any adjoining faces of the laminate body, or different surface regions on the same face of the laminate body. So long as the different external electrodes are separated from each other, the first internal electrode layers 12 and second internal electrode layers 13 may extend to other faces from the respective faces on which they are exposed to the surface regions of the laminate body.

The multilayer ceramic capacitor 10 has a size of, for example, 0.25 mm in length, 0.125 mm in width, and 0.125 mm in height, or 0.4 mm in length, 0.2 mm in width, and 0.2 mm in height, or 0.6 mm in length, 0.3 mm in width, and 0.3 mm in height, or 1.0 mm in length, 0.5 mm in width, and 0.5 mm in height, or 3.2 mm in length, 1.6 mm in width, and 1.6 mm in height, or 4.5 mm in length, 3.2 mm in width, and 2.5 mm in height; however, it is not limited to these sizes. The size of the multilayer ceramic capacitor 10 may satisfy, for example, “length>width≥height,” or “width>length≥height,” or “height>length≥width,” or “height>width≥length.”

The element body 11 has a capacitive part 16 and protective parts 17. The protective parts 17 constitute the peripheral parts of the ceramic body 11.

The protective parts 17 specifically comprise: cover parts 18 that are positioned on the outer sides in the stacking direction, i.e., outer sides in the Z-axis direction in FIGS. 1 to 3, of the capacitive part 16; side margin parts 19 that are positioned on the outer sides in the direction perpendicular to the stacking direction, i.e., outer sides in the Y-axis direction in FIGS. 1 to 3, of the capacitive part 16 and also representing regions where no internal electrodes are present; and end margin parts 20 that are positioned on the outer sides in the direction perpendicular to the stacking direction, i.e., outer sides in the X-axis direction in FIGS. 1 to 3, of the capacitive part 16 and also representing regions where the lead parts of the internal electrodes are present.

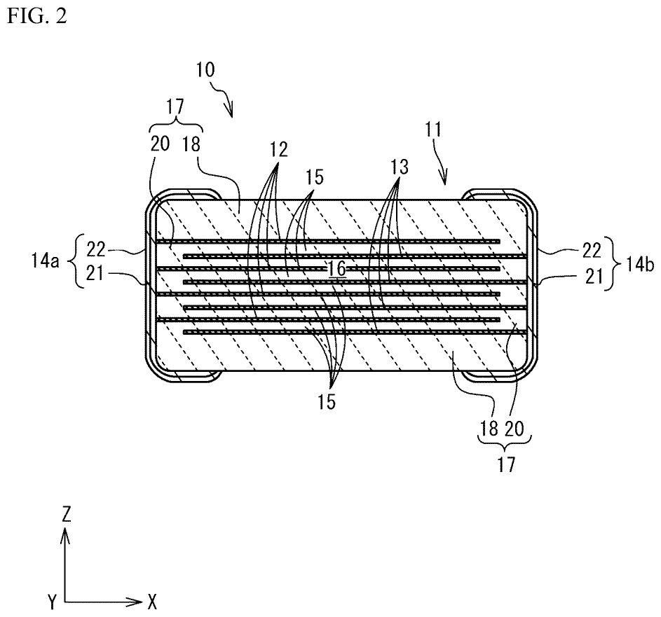

The capacitive part 16 is placed inward of the protective parts 17 and constitutes a functional part. In the capacitive part 16, multiple first internal electrode layers 12 and multiple second internal electrode layers 13 are stacked in the Z-axis direction with dielectric layers 15 (refer to FIG. 2) in between. The internal electrode layers 12, 13 are sheet-shaped, extending along the plane perpendicular to the stacking direction, i.e., X-Y plane in each of FIGS. 1 to 3, and placed alternately along the stacking direction, i.e., Z-axis direction in FIGS. 1 to 3. The structure of the dielectric layers 15 sandwiched between the first internal electrode layers 12 and second internal electrode layers 13 is explained later in detail.

The first internal electrode layers 12 and second internal electrode layers 13 use nickel (Ni), copper (Cu), tin (Sn), or other base metal, or an alloy containing any of the foregoing as the primary component. Platinum (Pt), palladium (Pd), silver (Ag), gold (Au), or other precious metal or an alloy containing any of the foregoing may also be used as the primary component of the first internal electrode layers 12 and second internal electrode layers 13. The primary component of the first internal electrode layers 12 and primary component of the second internal electrode layers 13 may be the same or different.

The dielectric layers 15 are formed by a dielectric ceramic. The multilayer ceramic capacitor 10 uses a dielectric ceramic of high dielectric constant in order to increase the capacitance of each dielectric layer 15 between the internal electrode layers 12, 13. The dielectric ceramic of high dielectric constant uses, as the primary component, a ceramic material having a perovskite structure expressed by the general formula ABO₃. It should be noted that this perovskite structure includes ABO_{3-α} that deviates from the stoichiometric composition of ABO₃. To be specific, the dielectric layers 15 uses (Ba,Sr,Ca)(Zr,Ti,Hf)O₃ as the primary component. The (Ba,Sr,Ca)(Zr,Ti,Hf)O₃ can contain barium (Ba) at the A-site and further contain strontium (Sr) and calcium (Ca) at the A-site, while it can contain at least one of zirconium (Zr) and titanium (Ti) at the B-site and further contain hafnium (Hf) at the B-site. In this Specification, Ba may be mentioned as a representative component with regard to the A-site. In the above case, the notation of “atomic ratio (at %) of Ba,” etc. should encompass the atomic ratio of components represented by Ba including also Sr and Ca. With regard to the B-site, Ti may be mentioned as a representative component, and the notation of “atomic ratio (at %) of Ti,” etc. should encompass the atomic ratio of components represented by Ti including also Zr and Hf. However, in other cases, the A-site and B-site may be denoted by their individual components explicitly indicated, depending on the context, etc.

The dielectric layers 15 contain, in addition to the aforementioned primary component, at least one of magnesium (Mg), manganese (Mn), holmium (Ho), ytterbium (Yb), and erbium (Er). Also, the dielectric layers 15 contain, in addition to the aforementioned primary component, at least one or more types of elements selected from the rare earth elements, first-row transition metal elements, or second-row transition metal elements. When selecting from the rare earth elements, the selection is made from scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), and thulium (Tm). The selection may also be made from the first-row transition metal elements or second-row transition metal elements, although listing thereof is omitted.

The protective parts 17 are also formed by a dielectric ceramic. Of the protective parts 17, preferably the cover parts 18 and end margin parts 20 are such that their primary component has the same composition as the dielectric layers 15 from the viewpoint of inhibiting internal stress, etc.

Of the protective parts 17, the side margin parts 19 have the same primary component as the dielectric layers 15.

The external electrodes 14a, 14b each have a base film 21 formed in a manner electrically connected to the lead parts of the internal electrodes led out to the surface of the ceramic body and thereby having conductivity, and a plated film 22 formed on top of the base film 21. The base film 21 is constituted by, for example, a baked film being a sintered conductive paste, a metal or other conductive sputtered film, a conductive resin film containing a metal filler, or the like. The base film 21 may also comprise multiple layered films including a layer offering good adhesion, a layer resistant to solder erosion, and the like. The plated film 22 is a film formed by means of electrolytic plating. Each of the external electrode 14a, 14b films is formed by, for example, a metal or alloy whose primary component is nickel (Ni), copper (Cu), tin (Sn), palladium (Pd), platinum (Pt), silver (Ag), gold (Au), or the like.

### [Detailed Structure of Dielectric Layers 15]

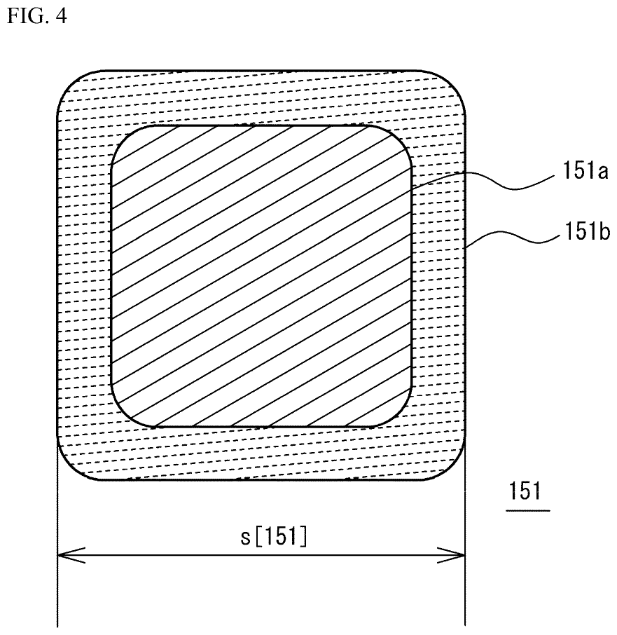

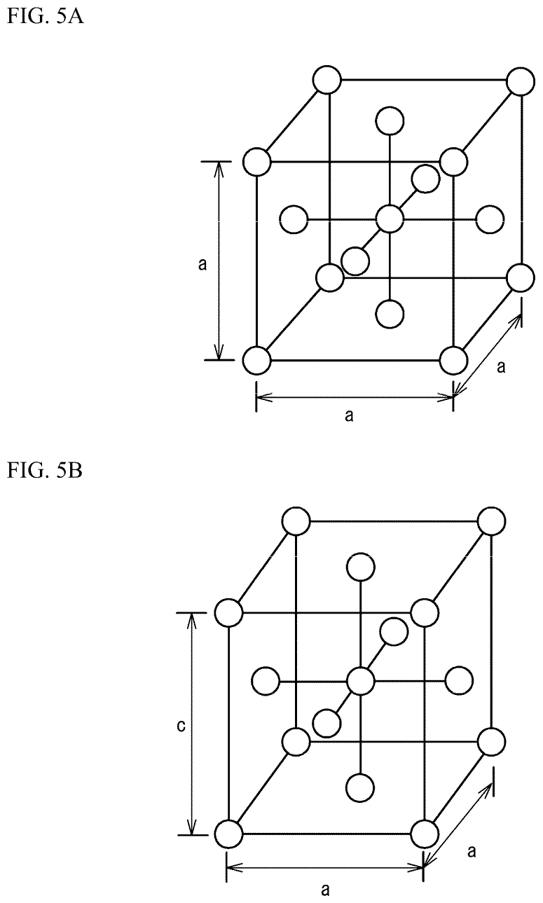

FIG. 4 is a drawing that schematically illustrates the state of a grain 151 forming a dielectric layer 15. It includes a core part 151a, and a shell part 151b surrounding the periphery of the core part 151a. The core part 151a is formed primarily by crystals of the cubic crystal system shown in FIG. 5A. By contrast, the shell part 151b is formed primarily by crystals of the tetragonal crystal system shown in FIG. 5B.

When the dielectric property of cubic crystals and dielectric property of tetragonal crystals are compared, cubic crystals tend to exhibit paraelectricity, while tetragonal crystals tend to exhibit ferroelectricity. Forming the dielectric layers 15 with ferroelectric grains makes it easy to ensure electrostatic capacitance, although doing so tends to worsen the DC bias properties. This is why, in this embodiment, the abundance ratio of crystals of the cubic crystal system (hereinafter simply referred to as “cubic crystal ratio”) in one grain 151 is set to 25% by mass or higher but no higher than 75% by mass. This ensures electrostatic capacitance while maintaining good DC bias properties at the same time. It is considered that keeping the cubic crystal ratio to 35% by mass or higher but under 65% by mass makes it easy to ensure electrostatic capacitance and maintain good DC bias properties. It should be noted that the cubic crystal ratio, defined as the abundance ratio of crystals of the cubic crystal system in one grain 151, can take an average measured value of multiple grains based on measurement using the XRD (X-ray diffraction) method.

In addition, preferably the average grain size of the grain 151 is 30 nm or larger but no larger than 70 nm. Also, more preferably the average grain size the grain 151 is 30 nm or larger but no larger than 60 nm, and yet more preferably 30 nm or larger but no larger than 50 nm. The smaller the average grain size of the grain 151, the better the DC bias properties become when an electric current is applied, which is desired.

Here, the average grain size of the grain 151 is obtained according to the procedure below, for example. First, the multilayer ceramic capacitor 10 is cut in such a way that a plane including the axis in the stacking direction of the first internal electrode layers 12, second internal electrode layers 13 and dielectric layers 15 is observed, and the cut cross-section is polished. A two-dimensional electron image of the dielectric layers 15 between the internal electrode layers 12, 13 in the capacitive part 16 of the cross-section is captured using an SEM (scanning electron microscope). Then, image processing and measuring software is used to measure the area of each grain in the view field to calculate the diameter of a circle having an equal area (Heywood diameter), from which an average value is further calculated. The SEM image capture positions consist of nine points that are points corresponding to one-fourth, one-half, or three-fourths the vertical length of the capacitive part 16 and one-fourth, one-half, or three-fourths the horizontal length of the capacitive part 16, and the average of the values taken at these points is defined as the average grain size of the applicable sample. If any of the nine points falls on an internal electrode part, the dielectric layer in its vicinity on the vertical center side is observed.

### [Method for Manufacturing Multilayer Ceramic Capacitor 10]

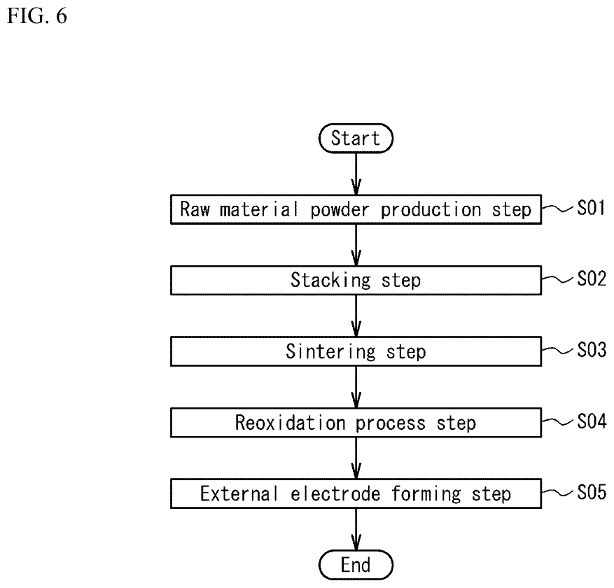

Next, the method for manufacturing the multilayer ceramic capacitor 10 is explained. FIG. 6 is a drawing that illustrates an example of the flow of how the multilayer ceramic capacitor 10 is manufactured.

### (Step S01: Raw Material Powder Production Step)

A dielectric material with which to form dielectric layers 15 is prepared. First, a (Ba,Sr,Ca)(Zr,Ti,Hf)O₃ ceramic powder is prepared. Regarding the method for synthesizing a (Ba,Sr,Ca)(Zr,Ti,Hf)O₃ ceramic powder, various methods have heretofore been known; for example, the solid phase method, sol-gel method, hydrothermal method, etc., are known. In this embodiment, the hydrothermal method is adopted.

Here, hydrothermal synthesis based on the hydrothermal method is explained in detail. This embodiment is characterized in that hydrothermal synthesis is performed at temperatures and pressures lower than under the conventional hydrothermal method. The synthesis, which is traditionally performed under the temperature and pressure conditions ranging from approx. 200° C. to 300° C. and several MPa to several 10's of MPa, etc., is performed in a synthesis environment of 120° C. or lower but no lower than 60° C. in temperature, and 600 hPa to 2000 hPa in pressure. Regarding the pressure, which is ideally lower, performing the synthesis at the water boiling point of 100° C. or higher requires a pressure condition slightly higher than atmospheric pressure. By performing the hydrothermal synthesis under such condition, a hydrothermally synthesized ceramic powder of high cubic crystal ratio can be obtained. In this embodiment, the hydrothermal synthesis is implemented in the aforementioned synthesis environment over a period of 30 minutes or longer but within 100 hours. The implementation period can be set as deemed appropriate within this range.

At least one of magnesium (Mg), manganese (Mn), holmium (Ho), ytterbium (Yb), and erbium (Er) is added to the obtained ceramic powder. This is to inhibit growth of the grain 151. This keeps the average grain size of the grains in the unsintered ceramic powder at 20 nm or larger but no larger than 50 nm. This average grain size of the grains in the ceramic powder can be obtained by measuring the powder using a laser-transmission type grain size analyzer, etc.

It should be noted that the ceramic powder may be BaTiO₃. For the A-site of the perovskite structure, Sr and Ca may be compounded instead of using a Ba-only composition. For the B-site of the perovskite structure, Zr and Hf may be compounded instead of using a Ti-only composition. If at least one type of element selected from Ba, Sr, and Ca, and at least one type of element selected from Ti, Zr, and Hf are contained, the atomic ratio (at %) of the Ba, Sr, and Ca combined can be equal to or higher than 1.020 times, or equal to or lower than 0.96 times, the atomic ratio (at %) of the Ti, Zr, and Hf combined. This is how an average grain size of 20 nm or larger but no larger than 50 nm may be achieved for the grains in the unsintered material ceramic powder. In other words, the Ba—Sr—Ca and Ti—Zr—Hf ratios may be adjusted to regulate the growth of the grains contained in the ceramic powder. It is considered that, by adjusting the ratio as above, Ba, Sr, and Ca, or Ti, Zr, and Hf, will increase on the grain surface and the atoms will inhibit the grains from reacting with one another, thereby inhibiting grain growth.

It should be noted that, when the atomic ratio (at %) of the Ba, Sr, and Ca combined is equal to or higher than 1.020 times the atomic ratio (at %) of the Ti, Zr, and Hf combined, the atomic ratio (at %) of the Ba, Sr, and Ca combined can be equal to or lower than 1.100 times the atomic ratio (at %) of the Ti, Zr, and Hf combined. Also, when the atomic ratio (at %) of the Ba, Sr, and Ca combined is equal to or lower than 0.96 times the atomic ratio (at %) of the Ti, Zr, and Hf combined, the atomic ratio (at %) of Ba can be equal to or higher than 0.900 times the atomic ratio (at %) of the Ti, Zr, and Hf combined. It should be noted that, as described above, in this Specification Ba may be mentioned as a representative component with regard to the A-site. The notation of “atomic ratio (at %) of Ba” should encompass the atomic ratio of components represented by Ba including also Sr and Ca. Also, Ti may be mentioned as a representative component with regard to the B-site. The notation of “atomic ratio (at %) of Ti” should encompass the atomic ratio of components represented by Ti including also Zr and Hf. However, in other embodiments, the A-site and B-site may be denoted by their individual components explicitly indicated, depending on the context, etc.

Also, specified additive compounds are added to the obtained ceramic powder, other than the foregoing, according to the purpose. The additive compounds include oxides of molybdenum (Mo), niobium (Nb), tantalum (Ta), tungsten (W), magnesium (Mg), manganese (Mn), vanadium (V), chromium (Cr), rare earth elements (yttrium (Y), samarium (Sm), europium (Eu), gadolinium (Gd), terbium (Tb), dysprosium (Dy), and Thulium (Tm)), as well as cobalt (Co), nickel (Ni), lithium (Li), boron (B), sodium (Na), potassium (K), silicon (Si), oxides of Si, or glasses.

The additive compounds are mixed into the ceramic powder and the mixture is calcined at 820 to 1150° C. Next, the ceramic powder is wet-mixed and then dried and pulverized. The average grain size of the calcined-and-pulverized ceramic powder is 20 nm up to 70 nm, or preferably 20 nm up to 50 nm. Further, the ceramic powder obtained as above may undergo a pulverization process to adjust the grain size, or a pulverization process in combination with a classification process to adjust the grain size, as necessary.

### (Step S02: Stacking Step)

Next, polyvinyl butyral (PVB) resin or other binder, ethanol, toluene, or other organic solvent, and plasticizer, are added to, and wet-mixed with, the obtained dielectric material. Using the obtained slurry, dielectric green sheets are coated on base materials according to the die-coater method or doctor blade method, for example, and dried.

Next, a metal conductive paste for forming internal electrodes that contains an organic binder is screen-printed, gravure-printed, or otherwise printed on the surface of the dielectric green sheets to place patterns for internal electrode layers. Ceramic grains may or may not be added to the metal conductive paste as a co-material. If ceramic grains are added as a co-material, preferably the primary component of the ceramic grains, although not specifically limited, is the same as the primary component ceramic of the dielectric layers 15.

Thereafter, the dielectric green sheets that have been peeled from the base materials are alternately stacked in such a way that the internal electrode layers 12, 13 will alternate with the dielectric layers 15 and that the edges of the internal electrode layers 12, 13 will be alternately exposed at the two length-direction end faces of the dielectric layers 15 and thereby alternately led out to the pair of external electrodes 14a, 14b having different polarities. For example, the total number of stacked layers is 100 to 500. Thereafter, multiple cover sheets that will become cover parts 18 are pressure-bonded on top and bottom of the laminate body constituted by the stacked dielectric green sheets, to obtain a ceramic laminate body. Thereafter, the obtained ceramic laminate body is cut to a specified chip size (for example, when the size of the multilayer ceramic capacitor 10 is 0.6 mm×0.3 mm×0.3 mm, this is a chip size that takes sintering shrinkage into consideration).

### (Step S03: Sintering Step)

The compact body obtained as above undergoes a binder removal process in an N₂ atmosphere, after which a metal paste that will become the base for external electrodes 20a, 20b is applied by the dip method, followed by 10 minutes to 2 hours of sintering at a sintering temperature of 1100 to 1300° C. in a reducing atmosphere of 10⁻⁵ to 10⁻⁸ atm in partial oxygen pressure.

### (Step S04: Reoxidation Process Step)

Thereafter, a reoxidation process may be performed at 600° C. to 1000° C. in an N₂ gas atmosphere.

### (Step S05: External Electrode Forming Step)

Thereafter, a base film 21 is formed. For the base film 21, an unfired electrode material is applied on the end faces, side faces, and principal faces of the ceramic laminate body. Regarding the method for application, the dip method is used, for example; however, any other conventionally known method, printing method, sputtering method, etc., or method representing a combination thereof, may also be used. Thereafter, the unfired electrode material is baked. The baking can be performed in a reducing atmosphere or low partial oxygen pressure atmosphere, for example. Once the base film 21 has been formed, the ceramic laminate body is dipped in a plating solution with which to form a plated film 22, to perform electrolytic plating. This forms a plated film 22 and thereby forms external electrodes 14a, 14b.

The foregoing explained embodiments of the present invention; however, the present invention is not limited to the aforementioned embodiment alone, and it goes without saying that various modifications can be added to the extent that doing so does not deviate from the purpose of the present invention.

### Examples

Next, the relative dielectric constants, as well as DC bias properties, or specifically rates of change in capacitance (%) when a direct current is applied, in the multilayer ceramic capacitors in the examples are explained together with the applicable values in the comparative examples.

The examples correspond to the multilayer ceramic capacitor 10 in the embodiment. Five different examples from Example 1 to Example 5 were prepared, representing different combinations of average grain size and cubic crystal ratio. Similarly, four different comparative examples from Comparative Example 1 to Comparative Example 4 were prepared, representing different combinations of average grain size and cubic crystal ratio. Also prepared were three different examples, from Conventional Example 1 to 3, of using a conventional ceramic powder. The examples, comparative examples, and conventional examples adopted a size of length×width×height=0.6 mm×0.3 mm×0.3 mm.

The average grain size was obtained according to the procedure below. First, the multilayer capacitor is cut in such a way that a plane including the axis in the stacking direction of the first internal electrodes, second internal electrodes, and dielectric layers was observed, and the cut cross-section is polished. A two-dimensional electron image of the dielectric layers between the internal electrodes in the capacitive part of the cross-section was captured using an SEM (scanning electron microscope). Then, image processing and measuring software was used to measure the area of each grain in the view field to calculate the diameter of a circle having an equal area (Heywood diameter), from which an average value was further calculated. The SEM image capture positions consist of nine points that are points corresponding to one-fourth, one-half, or three-fourths the vertical length of the capacitive part 16 and one-fourth, one-half, or three-fourths the horizontal length of the capacitive part 16, and the average of the values taken at these points was defined as the average grain size of the applicable sample. If any of the nine points falls on an internal electrode part, the dielectric layer in its vicinity on the vertical center side was observed.

The cubic crystal ratio (%) was calculated by XRD-analyzing the powder obtained by pulverizing each sample and measuring the ratio of tetragonal crystals and cubic crystals. Here, calculation of the cubic crystal ratio is explained further. First, the multilayer ceramic capacitor that serves as a sample is cut and polished to remove the external electrodes and protective parts, so that only the capacitive part (laminate body) constituted by the internal electrodes and the dielectric layers present between the internal electrodes remains. Next, this capacitive part is pulverized to obtain a measurement sample in powder form. This measurement sample in powder form is studied by XRD. The obtained X-ray diffraction pattern is fitted by Rietveld analysis using a multiphase model constituted by cubic crystals and tetragonal crystals, thereby calculating the ratios (% by mass) of the respective crystals, with the cubic crystals and tetragonal crystals together accounting for 100%. It should be noted that, although the measurement sample in powder form also contains Ni, which is an internal electrode component, Ni is not considered to affect the XRD measurement because it does not have a peak in the same region.

The relative dielectric constant was obtained by measuring the electrostatic capacitance using an LCR meter under the conditions of 25° C., 1 kHz, and 1 Vrms, and then calculating the relative dielectric constant from the crossing area, thickness of dielectric body, and number of dielectric layers, in the sample multilayer ceramic capacitor.

The rate of change in capacitance (%) represents the rate of decrease in capacitance when the capacitance resulting from applying a direct current of 4 V is compared with the capacitance under no load.

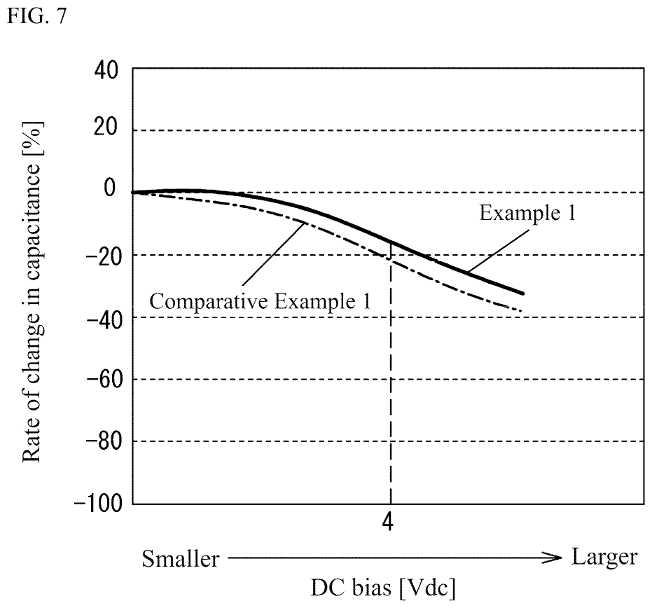

The sample was considered acceptable when its relative dielectric constant was 400 or higher and rate of change in capacitance was within-20%. Attention is drawn to FIG. 7 that illustrates the relationship of DC bias voltage and rate of change in capacitance in an example and that of a comparative example. As for the example, the rate of change in capacitance in Example 1 is shown, representing Examples 1 to 5. As for the comparative example, the rate of change in capacitance in Comparative Example 1 is shown, representing Comparative Examples 1 to 4.

TABLE 1

| | | | | Rate of change |
|---|---|---|---|---|
| | Average | Cubic | Relative | in capacitance |
| | grain | crystal | dielectric | when DC of 4 V |
| | size (nm) | ratio (%) | constant | is applied (%) |
| Example 1 | 66 | 40 | 553 | −18.3 |
| Example 2 | 69 | 32 | 588 | −17.1 |
| Example 3 | 59 | 47 | 510 | −15.9 |
| Example 4 | 48 | 62 | 413 | −12.9 |
| Example 5 | 32 | 73 | 408 | −11.2 |
| Comparative | 77 | 36 | 605 | −22.8 |
| Example 1 | | | | |
| Comparative | 28 | 43 | 363 | −8.6 |
| Example 2 | | | | |
| Comparative | 51 | 76 | 389 | −8.4 |
| Example 3 | | | | |
| Comparative | 46 | 23 | 501 | −21.9 |
| Example 4 | | | | |
| Conventional | 101 | 14 | 1812 | −37.2 |
| Example 1 | | | | |
| Conventional | 148 | 11 | 2631 | −44.1 |
| Example 2 | | | | |
| Conventional | 202 | 9 | 3209 | −58.7 |
| Example 3 | | | | |

Referencing Table 1, in Example 1, the average grain size was 66 nm and cubic crystal ratio was 40%. In Example 1, the relative dielectric constant was 553 and rate of change in capacitance was-18.3%. As a result, the sample in Example 1 was acceptable.

In Example 2, the average grain size was 69 nm and cubic crystal ratio was 32%. In Example 2, the relative dielectric constant was 588 and rate of change in capacitance was-17.1%. As a result, the sample in Example 2 was acceptable.

In Example 3, the average grain size was 59 nm and cubic crystal ratio was 47%. In Example 3, the relative dielectric constant was 510 and rate of change in capacitance was-15.9%. As a result, the sample in Example 3 was acceptable.

In Example 4, the average grain size was 48 nm and cubic crystal ratio was 62%. In Example 4, the relative dielectric constant was 413 and rate of change in capacitance was-12.9%. As a result, the sample in Example 4 was acceptable.

In Example 5, the average grain size was 32 nm and cubic crystal ratio was 73%. In Example 5, the relative dielectric constant was 408 and rate of change in capacitance was-11.2%. As a result, the sample in Example 5 was acceptable.

In Comparative Example 1, the average grain size was 77 nm and cubic crystal ratio was 36%. In Comparative Example 1, the relative dielectric constant was 605 and rate of change in capacitance was-22.8%. As a result, the sample in Comparative Example 1 was unacceptable. Here, the value of cubic crystal ratio in Comparative Example 1 represents a value roughly midway between the cubic crystal ratio in Example 1 and cubic crystal ratio in Example 2. Despite this, the sample in Comparative Example 1 became unacceptable, probably because the value of average grain size in Table 1 was larger (i.e., determined by the two parameters in combination: the abundance ratio of crystals of a cubic crystal system, and the average grain size of the grains). It should be noted that, although the average grain size in Example 2 was 69 nm, the sample in Example 2 was acceptable. This suggests that ideally the average grain size is 70 nm or smaller.

In Comparative Example 2, the average grain size was 28 nm and cubic crystal ratio was 43%. In Comparative Example 2, the relative dielectric constant was 363 and rate of change in capacitance was-8.6%. As a result, the sample in Comparative Example 2 was unacceptable.

In Comparative Example 3, the average grain size was 51 nm and cubic crystal ratio was 76%. In Comparative Example 3, the relative dielectric constant was 389 and rate of change in capacitance was-8.4%. As a result, the sample in Comparative Example 3 was unacceptable. Cubic crystals exhibit paraelectricity, while tetragonal crystals exhibit ferroelectricity. In Comparative Example 3, the ratio of cubic crystals was higher. This means that, although good DC bias properties were obtained, the sample had a small relative dielectric constant, thereby failing to achieve sufficient capacitance compared to the examples representing acceptable samples.

In Comparative Example 4, the average grain size was 46 nm and cubic crystal ratio was 23%. In Comparative Example 4, the relative dielectric constant was 501 and rate of change in capacitance was-21.9%. As a result, the sample in Comparative Example 4 was unacceptable.

Conventional Examples 1 to 3 represent examples of a conventional, general multilayer ceramic capacitor, using a powder hydrothermally synthesized at 250° C. and 25 MPa. In all cases, the average grain size was larger than the range specified under the present invention, while the percentage of tetragonal crystals was smaller than the range specified under the present invention, which means that, while a high relative dielectric constant was achieved, the rate of change in capacitance was substantially lower than-20%, and therefore the samples were found unacceptable.

As can be seen above, when the grains, which form the dielectric layers sandwiched by the internal electrode layers, satisfy both requirements: (i) an abundance ratio of crystals of a cubic crystal system is 25% by mass or higher but no higher than 75% by mass (or in any narrower ranges defined in the examples), and (ii) an average grain size of the grains is 30 nm or larger but no larger than 70 nm (or in any narrower ranges defined in the examples), the resultant multilayer ceramic electronic component can surprisingly and unexpectedly maintains a high dielectric constant while offering good DC bias properties.

The aforementioned embodiment explained the multilayer ceramic capacitor 10 as an example of multilayer ceramic electronic component; however, the present invention can be applied across the board to multilayer ceramic electronic components constituted by stacked dielectric layers and internal electrodes. Such multilayer ceramic electronic components include chip varistors, chip thermistors, and the like, for example.

In this disclosure, the terms “constituted by” and “having” refer independently to “typically or broadly comprising”, “comprising”, “consisting essentially of”, or “consisting of” in some embodiments. Further, in some embodiments, the material/composition including perovskite powders may consist of required/explicitly indicated elements described in the present disclosure; however, “consisting of” does not exclude additional components that are known equivalents to the elements and/or unrelated components such as impurities ordinarily associated with the elements. Further, in some embodiments which are silent as to known components used in this technology field, the known components can explicitly be excluded from the embodiments. Also, in some embodiments, any two numbers of a variable can constitute a workable range of the variable as the workable range can be determined based on routine work, and any ranges indicated may include or exclude the endpoints. Additionally, any values of variables indicated (regardless of whether or not they are indicated with “about”) may refer to precise values or approximate/rounded values and include equivalents, and may refer to average, median, representative, majority, etc. in some embodiments. In this disclosure, “a” may refer to a species or a genus including multiple species, and “the invention” or “the present invention” may refer collectively to at least one of the embodiments or examples explicitly or inherently disclosed herein. Further, in some embodiments, any one or more of the disclosed elements or components as options can be exclusively selected or can expressly be excluded, depending on the target piezoelectric ceramic to be manufactured, its target properties, etc., and/or for practical reasons, operational reasons, etc.

What is claimed:

1. A multilayer ceramic electronic component comprising an element body formed by alternately stacked internal electrode layers and dielectric layers,
wherein the dielectric layers formed between the internal electrode layers are constituted by grains wherein the grains have an abundance ratio of crystals of a cubic crystal system, which is 25% by mass or higher but no higher than 75% by mass, and
an average grain size of the grains that form the dielectric layers sandwiched by the internal electrode layers is 30 nm or larger but no larger than 70 nm.

2. The multilayer ceramic electronic component according to claim 1, wherein the abundance ratio of crystals of a cubic crystal system in the grains is 35% by mass or higher but under 65% by mass.

3. The multilayer ceramic electronic component according to claim 1, wherein the grains that form the dielectric layers comprise grains each having a core part primarily constituted by crystals of a tetragonal crystal system, and a shell part surrounding a periphery of the core part and primarily constituted by crystals of a cubic crystal system.

4. The multilayer ceramic electronic component according to claim 1, wherein the abundance ratio (%) of crystals of the cubic crystal system represents a value obtained by performing an X-ray analysis method on a measurement sample in powder form resulting from pulverizing a capacitive part constituted by the dielectric layers that are stacked with the internal electrodes and present between the internal electrodes, and then fitting an obtained X-ray diffraction pattern by Rietveld analysis using a multiphase model constituted by the crystals of the cubic crystal system and crystals of the tetragonal crystal system, thereby calculating the ratios (% by mass) of the crystals of the cubic crystal system and crystals of the tetragonal crystal system, respectively, with the crystals of the cubic crystal system and crystals of the tetragonal crystal system together accounting for 100%.

5. The multilayer ceramic electronic component according to claim 1, wherein the dielectric layers contain at least one of Mg, Ho, Yb, Er, and Mn.

6. The multilayer ceramic electronic component according to claim 1, wherein the grains constituting the dielectric layers contain at least one type of element selected from Ba, Sr, and Ca, as well as at least one type of element selected from Ti, Zr, and Hf, where an atomic ratio (at %) of the Ba, Sr, and Ca combined is equal to or higher than 1.020 times, or equal to or lower than 0.96 times, an atomic ratio (at %) of the Ti, Zr, and Hf combined.

7. A method for manufacturing a multilayer ceramic electronic component, comprising:
a step to obtain a ceramic slurry that contains a ceramic powder synthesized by a hydrothermal synthesis method and comprising core parts primarily constituted by crystals of a tetragonal crystal system, and shell parts surrounding a periphery of the core parts and primarily constituted by crystals of a cubic crystal system;
a step to produce green sheets using the ceramic slurry;
a step to form a laminate body in which the green sheets are alternately stacked with metal conductive layers; and
a step to form dielectric layers from the ceramic powder by sintering the laminate body;
wherein the hydrothermal synthesis method is implemented in a synthesis environment having a pressure of 600 hPa or higher but no higher than 2000 hPa, and a temperature of 60° C. or higher but no higher than 120° C.

8. The method for manufacturing multilayer ceramic electronic component according to claim 7, wherein an average grain size of the ceramic powder is 20 nm or larger but no larger than 50 nm and the ceramic powder contains BaTiO₃.

9. The method for manufacturing multilayer ceramic electronic component according to claim 7, wherein the ceramic powder is synthesized in the synthesis environment over a period of 30 minutes or longer but within 100 hours.

10. The method for manufacturing multilayer ceramic electronic component according to claim 7, wherein the step to obtain a ceramic slurry includes a step to add to the ceramic powder a grain growth-inhibiting additive that inhibits growth of the grains contained in the ceramic powder.

11. The method for manufacturing multilayer ceramic electronic component according to claim 10, wherein the grain growth-inhibiting additive is at least one of Mg, Ho, Yb, Er, and Mn.

12. The method for manufacturing multilayer ceramic electronic component according to claim 7, wherein the ceramic powder contains at least one type of element selected from Ba, Sr, and Ca, and at least one type of element selected from Ti, Zr, and Hf, and an atomic ratio (at %) of the Ba, Sr, and Ca combined is equal to or higher than 1.020 times, or equal to or lower than 0.96 times, an atomic ratio (at %) of the Ti, Zr, and Hf combined.

13. The method for manufacturing multilayer ceramic electronic component according to claim 12, wherein, when the atomic ratio (at %) of the Ba, Sr, and Ca combined is equal to or higher than 1.020 times the atomic ratio (at %) of the Ti, Zr, and Hf combined, the atomic ratio (at %) of the Ba, Sr, and Ca combined is equal to or lower than 1.100 times the atomic ratio (at %) of the Ti, Zr, and Hf combined.

14. The method for manufacturing multilayer ceramic electronic component according to claim 12, wherein, when the atomic ratio (at %) of the Ba, Sr, and Ca combined is equal to or lower than 0.96 times the atomic ratio (at %) of the Ti, Zr, and Hf combined, the atomic ratio (at %) of the Ba, Sr, and Ca combined is equal to or higher than 0.900 times the atomic ratio (at %) of the Ti, Zr, and Hf combined.
